(19) United States
(12) Patent Application Publication
(10) Pub. No.: US 2026/0197798 A1
(43) Pub. Date: Jul. 9, 2026

(54) UE-SPECIFIC TIME-BASED OFFSET FOR SERVING CELL END-OF-COVERAGE

(71) Applicant: Nokia Technologies Oy, Espoo (FI)

(72) Inventors: Enric JUAN, Aalborg (DK); Jeroen WIGARD, Aalborg (DK); Mads LAURIDSEN, Aalborg (DK)

(21) Appl. No.: 19/133,534

(22) PCT Filed: Nov. 16, 2023
(86) PCT No.: PCT/EP2023/082051

§ 371 Date: May 28, 2025

(30) Foreign Application Priority Data
Dec. 14, 2022 (FI) 20226104

(51) Int. Cl. H04W 64/00; H04W 36/32; H04W 84/06

(52) U.S. Cl. CPC H04W 64/006; H04W 36/324; H04W 84/06

(57) ABSTRACT

Example embodiments provide a procedure for controlling cell measurements performed by a client node in a non-terrestrial network. An apparatus may be configured to receive, from a base station providing a serving cell to a client node in a non-terrestrial network, parameters comprising at least one of a reference location of the serving cell, an indication of a movement direction of the serving cell or a cell radius parameter of the serving cell; obtain one or more offset parameters for at least one of a time or a distance with respect to the reference location; determine a cell coverage based on the reference location and the cell radius parameter; determine a measurement relaxation area within the cell coverage based on the one or more offset parameters and at least one of the parameters received from the base station; obtain a current location of the client node; determine when the client node is located within the measurement relaxation area; and determine at least some of mobility measurements not to be performed by the client node when the client node is located within the measurement relaxation area. Apparatuses, methods, and computer programs are disclosed.

### TECHNICAL FIELD

The present application generally relates to information technology. In particular, some example embodiments of the present application relate to an apparatus configured to determine a time-based offset for serving cell end-of-coverage, and in more particular, for earth-moving cells in a non-terrestrial network.

### BACKGROUND

Non-terrestrial networks (NTN) refer to networks or segments of networks that utilize an airborne or a spaceborne vehicle for transmission.

In an NTN system, 5G base stations (gNB) may be deployed, for example, on board satellites to provide a communication coverage over a very large area that may be otherwise unreachable by cellular networks. An NTN system can be used, for example, to connect IoT devices globally as well as to provide personal communication in remote areas and in disaster relief.

However, movement of both the satellites and devices communicative coupled with the satellites cause challenges for the NTN system based communications.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable controlling mobility measurements and triggering of mobility events based on a measurement relaxation area determined by a client node. This may be achieved by the features of the independent claims. Further implementation forms are provided in the dependent claims, the description, and the drawings.

According to a first aspect, an apparatus may comprise at least one processor; and at least one memory including instructions which, when executed by the at least one processor, cause the apparatus at least to receive, from a base station providing a serving cell to client node in a non-terrestrial network, parameters comprising at least one of a reference location of the serving cell, an indication of a movement direction of the serving cell or a cell radius parameter of the serving cell; obtain one or more offset parameters for at least one of a time or a distance with respect to the reference location; determine a cell coverage based on the reference location and the cell radius parameter; determine a measurement relaxation area within the cell coverage based on the one or more offset parameters and at least one of the parameters received from the base station; obtain a current location of the client node; determine when the client node is located within the measurement relaxation area; and determine at least some of mobility measurements not to be performed by the client node when the client node is located within the measurement relaxation area.

According to an example embodiment of the first aspect, the one or more offset parameters are received from the base station or determined by the apparatus.

According to an example embodiment of the first aspect, the at least one memory includes instructions which, when executed by the at least one processor, cause the apparatus to determine a second reference location of the serving cell based on the one or more offset parameters and the indication of the movement direction; determine a second cell coverage based on the second reference location and the cell radius parameter; and determine the measurement relaxation area to comprise an at least partially overlapping area of the second cell coverage and the first cell coverage.

According to an example embodiment of the first aspect, the at least one memory further comprises instructions which, when executed by the at least one processor, cause the apparatus to obtain a second cell radius parameter for the serving cell; determine a second reference location of the serving cell based on the one or more offset parameters and the indication of the movement direction; determine a second cell coverage based on the second reference location and the second cell radius parameter; and determine the measurement relaxation area based on an overlapping area of the second cell coverage with the first cell coverage.

According to an example embodiment of the first aspect, the indication of the movement direction comprises satellite ephemeris; and wherein the at least one memory further comprises instructions which, when executed by the at least one processor, cause the apparatus to determine the second reference position based on the satellite ephemeris and the one or more offset parameters.

According to an example embodiment of the first aspect, the one or more offset parameters comprise an array of time or distance parameters representing different distances from the first reference location; and the at least one memory comprises instructions which, when executed by the at least one processor, cause the apparatus to determine a trailing edge of the measurement relaxation area with respect to the movement direction extending across the first cell coverage perpendicular to the movement direction of the serving cell based on the array; and wherein the measurement relaxation area comprises a part of the first cell coverage defined by the trailing edge.

According to an example embodiment of the first aspect, the one or more offset parameters comprise an array of distances associated with a plurality of reference locations within the serving cell; and the at least one memory comprises instructions which, when executed by the at least one processor, cause the apparatus to determine a trailing edge of the measurement relaxation area with respect to the movement direction extending across the first cell coverage perpendicular to the movement direction of the serving cell based on the array; and wherein the measurement relaxation area comprises a part of the first cell coverage defined by the trailing edge.

According to an example embodiment of the first aspect, the at least one memory further comprises instructions which, when executed by the at least one processor, cause the apparatus to determine a measurement area based on the first cell coverage not included in the measurement relaxation area; determine when the client node is located within the measurement area; and perform the mobility measurements when the client node is located within the measurement area.

According to an example embodiment of the first aspect, the at least one memory further comprises instruction which, when executed by the at least one processor, cause the apparatus to compare a distance between the client node and a trailing edge of the measurement relaxation area with respect to the movement direction of the serving cell to a predefined threshold; and perform the mobility measurements when the distance between the client node and the trailing edge is less than the predefined threshold.

According to an example embodiment of the first aspect, the indication of the movement direction of the serving cell comprises satellite ephemeris; and wherein the at least one memory further comprises instruction which, when executed by the at least one processor, cause the apparatus to estimate a time until the client node is located at a trailing edge of the measurement relaxation area with respect to the movement direction based on a current location of the client node and the satellite ephemeris; set a timer based on the estimated time; and start the cell measurements based on an expiration of the timer.

According to an example embodiment of the first aspect, the indication of the movement direction of the serving cell comprises satellite ephemeris; and wherein the at least one memory further comprises instruction which, when executed by the at least one processor, cause the apparatus to estimate a point of time when the client node is located at a trailing edge of the measurement relaxation area with respect to the movement direction based on a current location of the client node and the satellite ephemeris; and perform the cell measurements at the estimated point of time.

According to a second aspect, an apparatus may comprise at least one processor; and at least one memory including instructions which, when executed by the at least one processor, cause the apparatus at least to send, to a client node, parameters related to a base station providing a serving cell to the client node in a non-terrestrial network comprising at least a reference location of the serving cell and one or more offset parameters for at least one of a time of a distance.

According to an example embodiment of the second aspect, the one or more offset parameters comprise at least one of an array of time or distance parameters representing different distances from the first reference location, an array of time or distance parameters representing different distances from the first reference location and positioned between 0 to 180 degrees with respect to an axis perpendicular to the moving direction, an array of distances associated with a plurality of reference locations within the serving cell, or an array of distances associated with a plurality of reference locations within the serving cell on the axis perpendicular to the moving direction.

According to a third aspect, a method may comprise receiving, from a base station providing a serving cell to a client node in a non-terrestrial network, parameters comprising at least one of a reference location of the serving cell, an indication of a movement direction of the serving cell and a cell radius parameter of the serving cell; obtaining one or more offset parameters for at least one of a time or a distance with respect to the reference location; determining a cell coverage based on the reference location and the cell radius parameter; determining a measurement relaxation area within the cell coverage based on the one or more offset parameters and at least one of the parameters received from the base station; obtaining a current location of the client node; determining when the client node is located within the measurement relaxation area; and determining at least some of mobility measurements not to be performed by the client node when the client node is located within the measurement relaxation area.

According to an example embodiment of the third aspect, the one or more offset parameters are received from the base station or determined by the client node.

According to an example embodiment of the third aspect, the method comprises determining a second reference location of the serving cell based on the one or more offset parameters and the indication of the movement direction; determining a second cell coverage based on the second reference location and the cell radius parameter; and determining the measurement relaxation area to comprise an at least partially overlapping area of the second cell coverage and the first cell coverage.

According to an example embodiment of the third aspect, the method comprises obtaining a second cell radius parameter for the serving cell; determining a second reference location of the serving cell based on the one or more offset parameters and the indication of the movement direction; determining a second cell coverage based on the second reference location and the second cell radius parameter; and determining the measurement relaxation area based on an overlapping area of the second cell coverage with the first cell coverage.

According to an example embodiment of the third aspect, the indication of the movement direction comprises satellite ephemeris; and the method further comprises determining the second reference position based on the satellite ephemeris and the one or more offset parameters.

According to an example embodiment of the third aspect, the one or more offset parameters comprise an array of time or distance parameters representing different distances from the first reference location; and the method further comprises determining a trailing edge of the measurement relaxation area with respect to the movement direction extending across the first cell coverage perpendicular to the movement direction of the serving cell based on the array; and wherein the measurement relaxation area comprises a part of the first cell coverage defined by the trailing edge.

According to an example embodiment of the third aspect, the one or more offset parameters comprise an array of distances associated with a plurality of reference locations within the serving cell; and the method further comprises determining a trailing edge of the measurement relaxation area with respect to the movement direction extending across the first cell coverage perpendicular to the movement direction of the serving cell based on the array; and wherein the measurement relaxation area comprises a part of the first cell coverage defined by the trailing edge.

According to an example embodiment of the third aspect, the method comprises determining a measurement area based on the first cell coverage not included in the measurement relaxation area; determining when the client node is located within the measurement area; and performing the mobility measurements when the client node is located within the measurement area.

According to an example embodiment of the third aspect, the method comprises comparing a distance between the client node and a trailing edge of the measurement relaxation area with respect to the movement direction of the serving cell to a predefined threshold; and performing the mobility measurements when the distance between the client node and the trailing edge is less than the predefined threshold.

According to an example embodiment of the third aspect, the indication of the movement direction of the serving cell comprises satellite ephemeris; and the method comprises estimating a time until the client node is located at a trailing edge of the measurement relaxation area with respect to the movement direction based on a current location of the client node and the satellite ephemeris; setting a timer based on the estimated time; and starting the mobility measurements based on an expiration of the timer.

According to an example embodiment of the third aspect, the indication of the movement direction of the serving cell comprises satellite ephemeris; and wherein the method comprises estimating a point of time when the client node is located at a trailing edge of the measurement relaxation area with respect to the movement direction based on a current location of the client node and the satellite ephemeris; and performing the mobility measurements at the estimated point of time.

According to a fourth aspect, a method may comprise sending, to a client node, parameters related to a base station providing a serving cell to the client node in a non-terrestrial network comprising at least a reference location of the serving cell and one or more offset parameters for at least one of a time of a distance.

According to an example embodiment of the fourth aspect, the one or more offset parameters comprise at least one of an array of time or distance parameters representing different distances from the first reference location, an array of time or distance parameters representing different distances from the first reference location and positioned between 0 to 180 degrees with respect to an axis perpendicular to the moving direction, an array of distances associated with a plurality of reference locations within the serving cell, or an array of distances associated with a plurality of reference locations within the serving cell on the axis perpendicular to the moving direction.

According to a fifth aspect, a computer program may be configured, when executed by a processor, to cause an apparatus at least to perform the following: receiving, from a base station providing a serving cell to a client node in a non-terrestrial network, parameters comprising at least one of a reference location of the serving cell, an indication of a movement direction of the serving cell and a cell radius parameter of the serving cell; obtaining one or more offset parameters for at least one of a time or a distance with respect to the reference location; determining a cell coverage based on the reference location and the cell radius parameter; determining a measurement relaxation area within the cell coverage based on the one or more offset parameters and at least one of the parameters received from the base station; obtaining a current location of the client node; determining when the client node is located within the measurement relaxation area; and determining at least some of mobility measurements not to be performed by the client node when the client node is located within the measurement relaxation area. The computer program may further comprise instructions for causing the apparatus to perform any example embodiment of the method of the third aspect.

According to a sixth aspect, an apparatus may comprise means for receiving, from a base station providing a serving cell to a client node in a non-terrestrial network, parameters comprising at least one of a reference location of the serving cell, an indication of a movement direction of the serving cell and a cell radius parameter of the serving cell; obtaining one or more offset parameters for at least one of a time or a distance with respect to the reference location; determining a cell coverage based on the reference location and the cell radius parameter; determining a measurement relaxation area within the cell coverage based on the one or more offset parameters and at least one of the parameters received from the base station; obtaining a current location of the client node; determining when the client node is located within the measurement relaxation area; and determining at least some of mobility measurements not to be performed by the client node when the client node is located within the measurement relaxation area. The apparatus may further comprise means for performing any example embodiment of the method of the third aspect.

According to a seventh aspect, a computer program may comprise instructions for causing an apparatus to perform at least the following: sending, to a client node, parameters related to a base station providing a serving cell to the client node in a non-terrestrial network comprising at least a reference location of the serving cell and one or more offset parameters for at least one of a time of a distance. The computer program may further comprise instructions for causing the apparatus to perform any example embodiment of the method of the fourth aspect.

According to an eighth aspect, an apparatus may comprise means for sending, to a client node, parameters related to a base station providing a serving cell to the client node in a non-terrestrial network comprising at least a reference location of the serving cell and one or more offset parameters for at least one of a time of a distance. The apparatus may further comprise means for performing any example embodiment of the method of the fourth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a non-terrestrial network comprising at least one network node and at least one client node according to an example embodiment.

FIG. 2 illustrates an example of UEs configured with different t-service parameters in Earth-moving cells;

FIG. 3 illustrates an example of a UE configured with a distance-based event;

FIG. 4 illustrates an example of a measurement relaxation area calculated by a UE according to an example embodiment;

FIG. 5 illustrates an example of distance arrays provided by a serving cell to a UE according to an example embodiment;

FIG. 6 illustrates an example of an apparatus configured to practice one or more example embodiments;

FIG. 7 illustrates an example message sequent chart between a UE, a serving cell and a target cell to determine a UE-specific time-based offset for serving cell end-of-coverage according to an example embodiment;

FIG. 8 illustrates an example of UEs entering a serving cell from different points according to an example embodiment;

FIG. 9 illustrates an example of a method for controlling mobility measurements in an NTN network according to an example embodiment; and

FIG. 10 illustrates an example of a method for assisting in controlling mobility measurements in an NTN network according to an example embodiment.

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

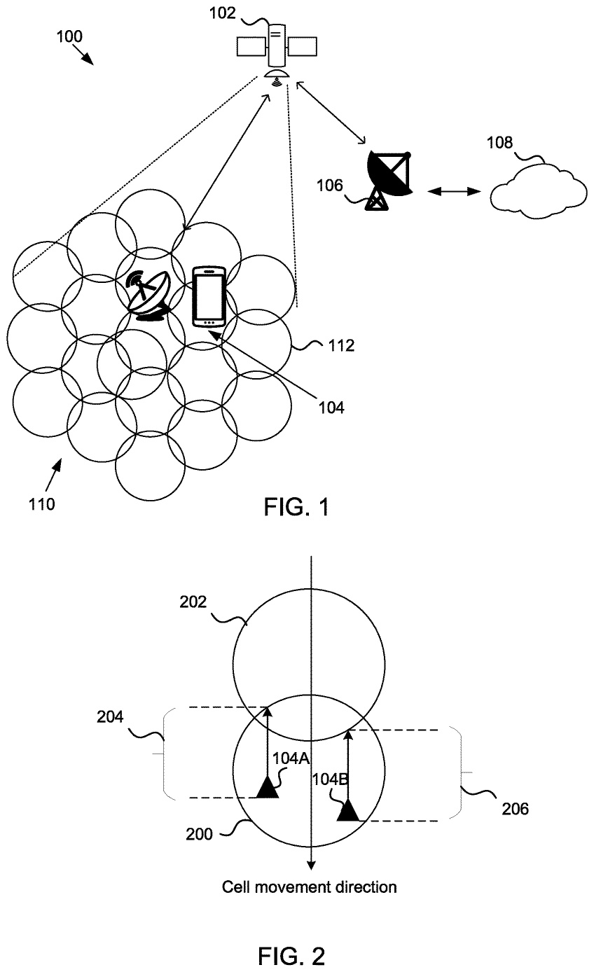

FIG. 1 illustrates an example of a non-terrestrial network comprising at least one network node and at least one client node according to an example embodiment.

The NTN 100 may comprise one or more base stations, represented by a gNB 102. The gNB 102 may be mounted on board an airborne vehicle or a spaceborne vehicle. The spaceborne vehicle may comprise, for example, a satellite in a low earth orbit (LEO), a medium earth orbit (MEO), a geostationary earth orbit (GEO) or in a highly elliptical orbit (HEO). A satellite comprising a base station may be referred to as a communications satellite. The communications satellite may be implemented as a regenerative (with on board processing by the gNB) payload. The NTN 100 may further comprise other base stations such as one or more gNBs located on the ground-level. In this case, the satellite may be implemented as a transparent payload-based satellite and configured to act as an analog radiofrequency repeater for the base station located on the ground. For example, the satellite may be configured to relay and/or amplify and forward signals received from a gNB located, for example, between a satellite gateway 106 and a data network 108. Hence, the satellite (or other airborne/spaceborne vehicle) may be configured to act as a relay node or a base station, depending on the implementation. The gNB 102 on board the satellite or on the ground may be configured to generate several beams over a given service area bounded by its field of view 110. Footprints 112 of the beams may refer to the ground area that transponders of the communications satellite offer cell coverage. A cell coverage may refer to a geographical area covered by a network. The field of view 110 of the satellite may depend on an on board antenna diagram and a minimum elevation angle. A gNB may be generally referred to as a network node or a network device. Although depicted as a single device, a network node may not be a stand-alone device, but for example a distributed computing system coupled to a remote radio head.

The NTN 100 may further comprise one or more client nodes, which may be also referred to as user nodes or UE. For example, the network 100 may comprise a UE 104. The UE 104 may be a terrestrial UE located at a ground level. A UE may comprise, for example, a mobile phone or a IoT device. The UE 104 may communicate with one or more of the base stations via wireless radio channel(s). Communications between the UE 104 and the gNB 102 may be bidirectional. Hence, any of the devices may be configured to operate as a transmitter and/or a receiver. The UE 104 may be served by the gNB 102 within a targeted service area illustrated by the footprints 112 within the field of view 110.

The NTN 100 may comprise one or more satellite gateways 106 configured to connect the NTN 100 to the data network 108 via a core network. The satellite gateway 106 may be also referred to as an NTN gateway. A NTN gateway may be configured to connect a satellite to a gNB (in case of a transparent payload) or directly to the core network (in case of a regenerative payload). The satellite gateway 106 may be configured to transmit data from the satellite to the data network 108, such as local area network, and to transmit data to the satellite from the data network 108. The gNB 102 may be configured to communicate with the satellite gateway 106 over a communication interface, such as for example a control plane interface or a user plane interface NG-C/U. The NTN 100 may comprise a feeder link or radio link between the satellite gateway 106 and the satellite/gNB 102, and a service link or radio link between the UE 104 and the satellite/gNB 102.

The NTN network 100 may be configured for example in accordance with the 5th Generation digital cellular communication network, as defined by the 3rd Generation Partnership Project (3GPP). In one example, the NTN 100 may operate according to 3GPP 5G-NR. In one example, the NTN 100 may operate according to 3GPP IoT over NTN, which may be based on NB-IoT (narrowband IoT) and eMTC (enhanced machine type communications) supporting NTN. It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

As mentioned, there are different types of satellite orbits that may be used for NTN access including Low Earth Orbit (LEO) satellites. The LEO satellites may be configured to orbit at approximately 600 km above the Earth. A typical beam footprint size for a LEO satellite may be assumed to be between 50-1000 km in diameter. Hence, one LEO satellite can cover a very large area on the earth which may include multiple countries. Due to the low altitude, the LEO satellites move with a speed about 7.5 km/s relative to Earth.

In 3GPP, Earth-fixed cells (EFC) and Earth-moving cells (EMC) may be considered. The former (EFC) entails the satellite continuously adjusting the satellite beam pointing direction to fix a NR (new radio) cell and a NR beam to a specific point on Earth. The latter option (EMC) entails the satellite beam pointing direction being fixed and thus the footprint of a beam (i.e., NR cell) is moving on Earth. In EMC-based NTN the mobility is mainly due to satellite movement as the satellites move much faster than UEs on the ground.

In an NTN system, a base station may be configured to broadcast a parameter called t-service as part of serving cell information. The t-service parameter is cell-specific and common for all UEs in the same cell. The t-service parameter is designed for EFC, wherein a value of the t-service parameter indicates the time when the EFC will stop serving the area, which it is currently covering.

For an EMC, UEs may have different cell serving duration depending on the UE's location within the cell. Thus, stop serving time of the cell of the UE (i.e., t-service) may vary for each UE. Unlike for quasi-Earth-fixed cells, a common t-service in Earth-moving cells may be inaccurate and difficult to use, because the remaining time will depend on the UE's relative location in the moving cell. FIG. 2 illustrates an example of the problem. FIG. 2 shows two UEs (104A, 104B) connected to a serving cell 200. As the serving cell 200 moves from top to bottom, the UEs 104A, 104B enter in a coverage area of a target cell 202 at different times. If both UEs 104A, 104B were configured with a common t-service, the following issues arise:

Target cell measurements/CHO (conditional handover) execution may be initiated too early. This may increase UE power consumption, which may be critical for IoT (internet-of-things) UEs. Assuming a stop serving time of the serving cell 200 is less than the t-service value 206 of the second UE 104B, the second UE 104B may initiate the measurement of the target cell 202 too early.

Target cell measurements/CHO execution may be also initiated too late, which increases RLF (radio link failure) likelihood and causes a sub-optimal use of the available resources. Assuming the stop serving time of the serving cell 200 is greater than the t-service value 204 of the first UE 104A, the first UE 104A may initiate the measurement of the target cell 202 late.

Also, in the case where the network would be able to configure every UE with the correct timers, any movement of the UE would require the network to update the timers. Such UE-specific signaling would lead to a large signaling overhead. Even for stationary UEs, dedicated UE-specific signaling may be needed as compared to the broadcast approach for t-service in EFC.

For a time-based conditional handover (CHO), a UE can execute CHO during a specific time. The execution condition may be determined by the network, mainly based on a stop serving time of the serving cell and a start serving time of candidate cells. For quasi-earth fixed cell, these time points are unified and valid always for all the UEs under the serving cell.

However, for an Earth-moving cell, there may be various stop times of a serving cell and start times of candidate cells for each UE depending on a location of the individual UE. To support time-based CHO, a gNB would need to calculate the CHO execute times based on a current location reported by the UE and configure the CHO execution conditions to the UE. In this case, once the UE moves, the stop serving time of the serving cell and the start serving time of the candidate cell will be changed, and the execution condition may become invalid. Therefore, CHO configuration update may be needed which will introduce signaling overhead especially for a UE with high speed. Hence, for the Earth-moving cell scenario, enhancements may be needed to solve the problem of invalid configuration caused by UE mobility to support time based CHO.

For an NTN-NTN cell reselection with an Earth-moving cell, providing parameters of serving cell to a UE for the UE to estimate the stop serving time of the serving cell may be considered. These parameters of the serving cell can comprise satellite orbital parameters, location coordinates of cell center and/or a radius of cell coverage.

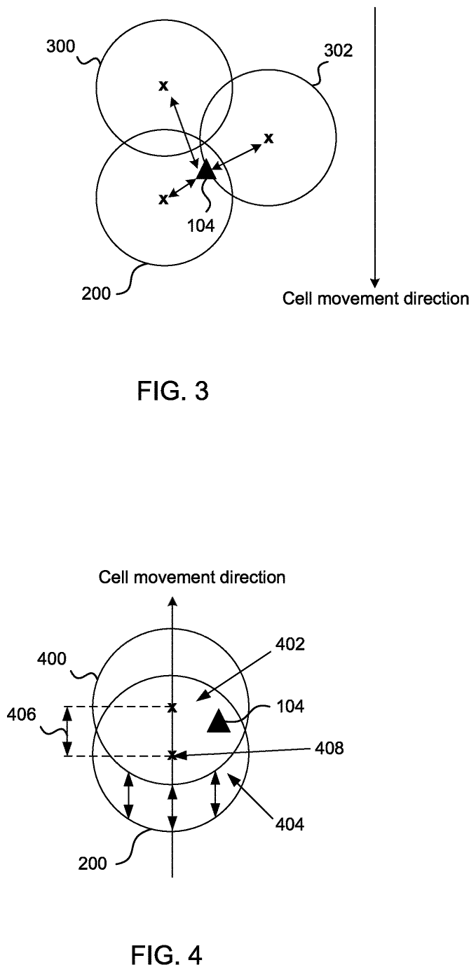

Apart from time-based solutions, UEs may be configured with a distance-based event. Despite the network/UE may be capable of predicting the cell movement, the UE may measure neighboring cells that may not cover the UE as the cell moves away. FIG. 3 illustrates an example of the problem. In this case, as cells (e.g., a serving cell 200, a previous serving cell 300 and a neighbor cell 302) move from top to bottom, a UE 104 stays in the serving cell 200 until the cell edge (i.e., bottom part of the serving cell 200) is reached, wherein the UE 104 is ready to handover to a new cell. Since the distance-based event may be based on snapshot-based distance measurements, without considering any delta, a UE could trigger undesired mobility event to neighboring cells that meet the distance conditions but may not cover the UE, as the cell moves away. Furthermore, the UE may perform unnecessary radio measurements on these cells, making a sub-optimal use of the available resources and increasing the UE power consumption.

In addition, RSRP/RSRQ (reference signal received power/quality) cell measurements may be used to determine an end of coverage of the serving cell. However, in NTN due to the near-far effect, radio measurements may not be reliable due to the logarithmic behavior of propagation losses and long communication distances. This means the received power difference between a cell edge and a cell center can be just a few decibel.

An objective is to alleviate at least one of the above drawbacks. This disclosure is related to 5G New Radio non-terrestrial network (NTN) base stations/satellites (gNB) and mobiles (UE) in a deployment with Earth moving cells. According to an example embodiment, a client node may be configured with satellite cell moving related information and configured to perform measurements when needed, e.g., according to a satellite cell change in a predicted time. The client node may be configured to obtain at least one time/distance offset parameter, for example, broadcasted by the base station or determined by the client node. The client node may be configured to calculate when in time it will cross the cell edge, in conjunction with known own position of the client node, satellite ephemeris and cell radius broadcasted by the base station. The client node may be configured to pause or relax handover measurements before the calculated time based on the at least one time/distance offset parameter. In an example embodiment, an array of time/distance-based offset parameters, specifying distances measured from a cell center that may define a trailing border of the measurement relaxation area spanning the whole width (i.e., perpendicular to direction of cell movement) of the cell. The UE may be configured to pause the handover measurements until it crosses the trailing border. Hence, the client node may be configured to take into account the direction of cell movement in the interpretation of the broadcasted or determined time/distance offset parameter(s).

Advantages of example embodiments may comprise that a client node, such as a UE, spends less time and energy on measurements in Earth-moving cells. Further, signaling overhead may be limited, because the network can provide information for the UE to determine pausing/relaxing and/or starting times of cell measurements of serving/target cells, for example in SIB (system information block), after which the UE may apply the measurement relaxation based on own location. This means, that UE-specific configuration may not be needed.

FIG. 4 illustrates an example scenario where a UE 104 is configured to calculate a measurement relaxation area 402 according to an example embodiment. Power consumption of the UE may be reduced because mobility measurements and triggering of mobility events may be enhanced based on the calculated measurement relaxation area. The mobility measurements may comprise at least one of serving cell measurements and/or target/neighbor cell measurements. The target/neighbor cell measurements may comprise intra- or inter-frequency or even inter-RAT measurements (with reference to the serving cell's frequency and RAT type).

In FIG. 4, a serving cell 200 is the actual serving cell providing a first cell coverage for the UE 104 and an overlapping area between the serving cell 200 and a cell 400 providing a second cell coverage for the UE 104 illustrates the measurement relaxation area 402. A measurement relaxation area may be configured to comprise an at least partially overlapping area of the second cell coverage and the first cell coverage. An area of the serving cell 200 not overlapping with the cell 400 or the measurement relaxation area 402 illustrates a measurement and/or a handover area 404.

The UE 104 may be configured to calculate a time t-offset. The time t-offset may be used by the UE 104 to trigger serving/target cell measurements. Based on the time t-offset, the UE 104 may be configured to determine, for example, when a cell centre of the serving cell 200 is at a new reference location.

A base station providing the serving cell 200 may be configured to broadcast data comprising a reference location such as a serving cell centre 408 and at least one offset parameter 406 such as a time/distance offset (t-offset/d-offset). The offset parameters may be determined by the base station, for example, based on a UE capability or an estimate of a reasonable time to perform measurements by the UE. The data may be broadcasted, for example, as part of SIBX.

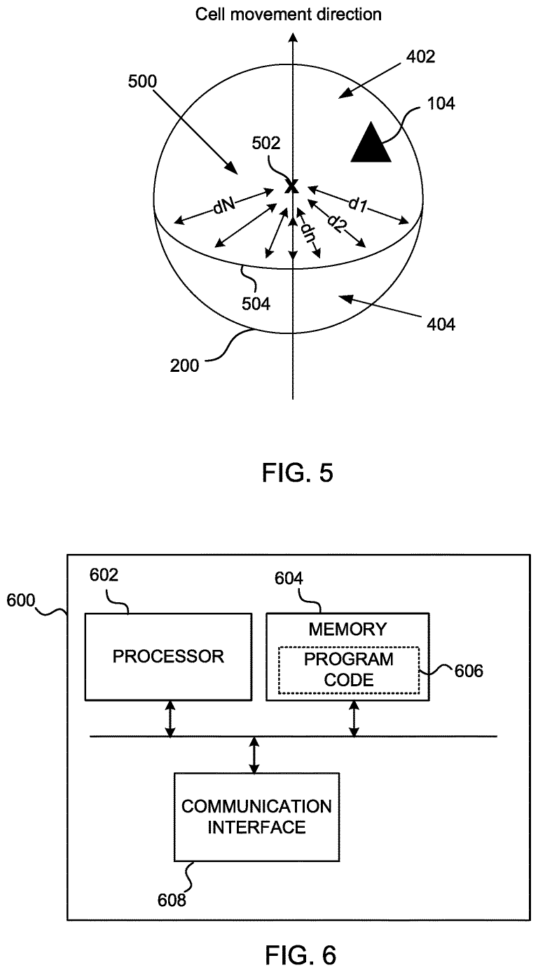

Alternatively, the base station providing the serving cell 200 to the UE 104 may be configured to provide an array of t/d-offset values 500 representing different distances [d1, d2, d3, . . . , dn, . . . , dN) from a serving cell 200 reference location 502 (e.g., the serving cell centre) to a border between the measurement/HO area 404 and the measurement relaxation area 402, as illustrated in FIG. 5. The border may correspond to a trailing edge 504 of the measurement relaxation area with respect to a movement direction of the serving cell.

The UE 104 may be configured to obtain also other serving cell parameters, such as satellite orbital parameters, a satellite ephemeris, or a cell radius parameter. The parameters may be received from the base station. Based on the satellite orbital parameters/ephemeris and the t-offset, the UE 104 may be configured to calculate a new cell reference location. For example, the UE 104 may use the at least one offset parameter 406, e.g. t-offset=2 s, to determine how far the serving cell's 200 cell centre/reference location 408 moves within 2 s (based on the ephemeris). For example, if the relative speed on earth is 7.5 km/s it would correspond to the cell centre moving 15 km in the direction of the satellite's movement. If the at least one offset parameter 406 comprises a distance, the UE 104 can be configured to determine the new cell reference location by directly shifting the serving cell centre (reference location 408) according to the distance. The new cell reference location may be used by the UE 104 to estimate the measurement relaxation area 402. The new cell reference location may correspond to a centre of the relaxation measurement area.

The UE 104 may be configured to use the cell radius parameter in combination with the new cell reference location (400) to determine the measurement relaxation area 402. The UE 104 may be configured to determine a first cell coverage associated with the serving cell 200, for example, based on the received reference location and the cell radius parameter. The UE 104 may be configured to determine a second cell coverage associated with the cell 400, for example, based on the new reference location and the cell radius parameter. The UE 104 may then determine the measurement relaxation area 402 based on an overlapping area of the first and the second cell coverage.

In one embodiment, the UE 104 may be configured to receive a different cell radius parameter from the base station for determining the measurement relaxation area 402. Hence, the UE 104 may be configured to determine the first and the second cell coverages based on different cell radius parameters.

Alternatively, the array of t/d-offset values 500 may be used by the UE 104 to determine the measurement relaxation area 402 within the first cell coverage based on the indicated trailing edge 504 of the measurement relaxation area.

If the UE 104 is within the measurement relaxation area 402, the UE 104 may be configured to relax/pause (target) cell measurements. The UE 104 may be configured to compare its own location obtained, for example, based on a GPS signal, to a geographical area covered by the measurement relaxation area.

When the trailing edge 504 of the measurement relaxation area 402 is reached (i.e., the UE 104 is located in the serving cell 200 in an area which is not overlapped by the cell 400), the UE 104 may be configured to perform the target/serving cell measurements.

The disclosure is written in context of a RRC connected UE, but it could also be applied for measurement relaxation and cell reselection of RRC idle/inactive UEs, for example.

FIG. 6 illustrates an example of an apparatus 200 configured to practice one or more example embodiments.

The apparatus 600 may comprise at least one processor 602. The at least one processor 602 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 600 may further comprise at least one memory 604. The memory 604 may be configured to store, for example, computer program code 606 or the like, for example operating system software and application software. The memory 604 may comprise one or more volatile memory devices, one or more non-volatile memory devices, and/or a combination thereof. For example, the memory 604 may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise one or more communication interfaces 608 configured to enable apparatus 600 to transmit information to other apparatuses, such as the satellite/gNB 102 or the UE 104. The communication interface 608 may be also configured to enable the apparatus to receive information from other apparatuses, such as the satellite/gNB 102 or the UE 104. The communication interface 608 may be configured to provide at least one wireless radio connection, such as for example a 3GPP mobile broadband connection (e.g. 3G, 4G, 5G). However, the communication interface 608 may be configured to provide one or more other type of connections, for example a wireless local area network (WLAN) connection such as for example standardized by IEEE 802.11 series or Wi-Fi alliance; a short range wireless network connection; a wired connection such as for example a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 600 may comprise for example a computing device such as for example a base station, a network node, a server device, a client node, a mobile phone, a tablet computer, a laptop, a IoT device or the like. In one example, the apparatus 600 may comprise a vehicle such as for example a satellite. Although the apparatus 600 is illustrated as a single device it is appreciated that, wherever applicable, functions of apparatus 600 may be distributed to a plurality of devices.

When the apparatus 600 is configured to implement some functionality, some component and/or components of the apparatus 600, such as for example the at least one processor 602 and/or the memory 604, may be configured to implement this functionality. Furthermore, when the at least one processor 602 is configured to implement some functionality, this functionality may be implemented using program code 606 comprised, for example, in the memory 604.

For example, the apparatus 600 may comprise a client node. The client node may be configured to trigger at least one of serving cell or target cell measurements based on measurement criteria calculated by the client node based on estimated movement of the serving cell. The client node may be configured to determine a measurement relaxation area based on a cell reference location and one or more time/distance offset parameters received from a base station providing the serving cell, and to pause and/or start the cell measurements based on a location of the client node with respect to the measurement relaxation area. Alternatively, the one or more time/distance offset parameters may be determined by the client node. Hence, when the time/distance offset parameter is determined by the client node, instead of using broadcasted offset parameters from the base station, which may be the same for all client nodes, the client node may be able to take into account how fast it is able to perform measurements. In an embodiment, the base station may be configured to send a plurality of offset parameters to the client node, and the client node may be configured to select one or more of the plurality of offset parameters based on capabilities of the client node.

For another example, the apparatus 600 may comprise a network node and be configured to send, to a client node, parameters related to an earth-moving cell providing a serving cell comprising at least a reference location of the serving cell and one or more offset parameters for at least one of a time of a distance. The parameters may further comprise at least one of an indication of a movement direction of the serving cell or a cell radius parameter of the serving cell.

The functionality described herein may be performed, at least in part, by one or more computer program product components such as software components. According to an embodiment, the apparatus 600 comprises a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (GPUs).

The apparatus 600 may comprise means for performing at least one method described herein. In one example, the means comprises the at least one processor 602, the at least one memory 604 including program code 606 configured to, when executed by the at least one processor 602, cause the apparatus 600 to perform the method.

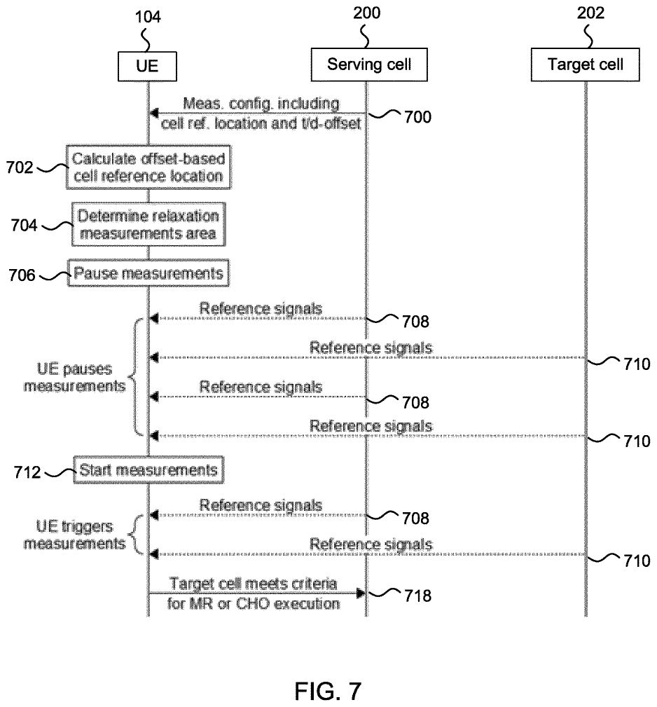

FIG. 7 illustrates an example message sequence chart for signalling between a UE 104, a serving cell 200 and a target cell 202 for determination of a measurement relaxation area and evaluation of time/distance/measurement-based CHO conditions.

At an operation 700, the UE 104 may be configured to obtain at least one t/d-offset parameter from a base station associated with the serving cell 200. For example, the base station/serving cell 200 may be configured to send to the UE 104 a measurement configuration comprising a reference location of the serving cell 200 and the at least one t/d-offset parameter. The UE 104 may be configured to obtain also other serving cell parameters, such as at least one of a satellite ephemeris and one or more cell radius parameters.

Thereafter, the UE 104 may be configured to determine when the UE 104 can relax/pause mobility measurements. At an operation 702, the UE 104 may be configured to calculate a second reference location for the serving cell 200 based on the at least one t/d-offset. At an operation 704, the UE 104 may be configured to determine the measurement relaxation area. For example, the UE 104 may be configured to determine a first cell coverage associated with the first reference location received at 700 and a second cell coverage associated with the second reference location determined at 702. The cell coverages may be determined, for example, based on the obtained serving cell parameters.

Alternatively, the UE 104 may be configured to calculate the measurement relaxation area based on the array of distances 500 illustrated in FIG. 5. In this case, the serving cell/base station may be configured to signal to the UE 104 the array with N distances, [d1, d2, . . . , dn, . . . , dN]. Considering the first reference location as a origin, the distance elements [d1, d2, . . . , dn, . . . , dN] may be configured to define a set of N vectors. The set of N vectors may be, for example, equally spaced between said vectors. The vectors may be configured to lie between 0 deg and 180 deg (where a point (0,0) of a local coordinates system is the first reference location). The vectors may be configured to point away from an axis perpendicular to the moving direction. The ends of the vectors may draw the trailing edge 504 of the measurement relaxation area which may correspond to an edge of the second cell coverage. Yet another alternative would be that the arrows are given with reference in the actual serving cell (based on the first reference location and radius) on a horizontal axis with respect to a moving direction of the serving cell. The arrows may be, for example, equally spaced on the horizontal axis locating perpendicular with respect to the moving direction.

At an operation 706, the UE 104 may be configured to pause or relax mobility measurements based on the measurement relaxation area. When the mobility measurements are paused, the UE 104 may be configured not to measure any of reference signals 708 received from the serving cell 200 and reference signals 710 received from the target cell 202. When the mobility measurements are relaxed, the UE 104 may be configured to perform the mobility measurements at a reduced rate. Hence, the UE 104 may be configured to not perform any mobility measurements, or to perform less mobility measurements when the UE 104 is located within the measurement relaxation area, compared to a situation where the UE 104 is located outside the measurement relaxation area but within the serving cell.

The UE 104 may be configured to evaluate when the trailing edge of the measurement relaxation area is reached, and resume intra/inter-frequency cell measurements at an operation 712 after the trailing edge of the measurement relaxation area is reached. After the UE 104 has again started/triggered the mobility measurements at the operation 712, the UE 104 may be configured to measure the subsequently received reference signals 708, 710.

Once the UE 104 has estimated the measurement relaxation area, there are multiple options for the UE 104 to decide when it has reached the trailing edge of the measurement relaxation area. In a location-based manner, the UE 104 may be configured to trigger measurements based on a predefined threshold for distance and a distance between its own position and the trailing edge. The predefined threshold may be determined by the UE 104 or received from the serving cell. The UE 104 may be configured to determine current location of the UE 104, for example, using GNSS, such as a GPS signal. The UE 104 may be also configured to determine its own location with 3GPP-based positioning means or based on a hard-coded location when the UE 104 is a stationary device. Alternatively, the UE 104 may be configured to adopt a time-based approach, wherein the UE 104 may be configured to either set a timer based on an estimated time when the UE 104 will be located at the trailing edge and trigger the mobility measurements based on an expiration of the timer or to compare an absolute UTC time of the UE 104 against a UTC time reference.

At an operation 718, the UE 104 may be configured to inform the serving cell 200 when the target cell 202 meets predefined criteria for a measurement report (MR) or conditional handover execution based on the received and measured reference signals 708, 710 after the operation 712.

Hence, in Earth-moving cells, the UE 104 may spend less time and energy on mobility measurements based on the measurement relaxation area determined by the UE 104. With the described different methods for the UE to estimate when mobility measurements should be performed and when location/time-based CHO conditions can be evaluated, no UE-specific signalling may be required.

Further, the signaling overhead may be limited, because the network can provide the information for determining the measurement relaxation area, for example in SIB, after which the UE 104 may apply the measurement relaxation based on own location of the UE 104, i.e., there is no need for UE-specific configuration.

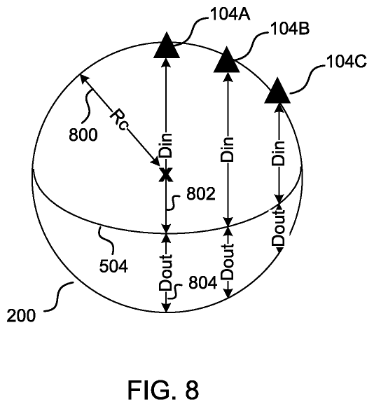

The following examples provide some rough estimations to bring forward the advantages of the solution. The examples are illustrated with reference to FIG. 8. Calculations of the examples may be based on:

Measurements of the serving and target cells signal references may be performed by a UE entering the serving cell at a first location (UE 104A), at a second location (UE 104B), and at a third location (UE 104C), for example, every 20 ms.

A serving cell radius (Rc) 800 may be 25 km.

A satellite comprising a gNB may move at a speed of 7.8 km/s.

Parameters d_in 802 and t_in are a distance and time between the UE and a trailing edge of the measurement relaxation area 504, respectively.

Parameters d_out 804 and t_out are a distance and time between the trailing edge of the measurement relaxation area 504 and a geometric edge of the serving cell 200.

A first example considers an Earth-moving cell flying over the UE 104A, which cell centre will pass through the UE location. This means that the UE 104A may spend a maximum possible time in the serving cell 200 (i.e., 2*25 km/7.8 km/s=6.4 s).

The UE 104A may be able to identify a new detectable intra-frequency cell within a time T_identify. Assuming a neighbor cell is synchronous with the serving cell 200 and no discontinuous reception (DRX) is configured, T_identify may not exceed 800 ms. The value of 800 ms may be used as the maximum time that the UE 104A may need out of the measurement relaxation area, t_out, to identify and measure the upcoming target cell.

Given t_out=800 ms and the satellite speed of 7.8 km/s, the distance that the UE 104A may cover out of the measurement relaxation area is d_out=6.24 km.

Considering that Rc=25 km, then d_in=2*Rc−d_out=43.76 km. Thus, t_in=5.6 s. Under these assumptions, in 5.6 s, the UE 104A can save 87.5% of the energy used for measuring compared to measuring continuously.

In a second example, it may be assumed that an average distance between two points in a circle is d_avg~Rc*4/n=31.83 km. Repeating the same calculations for the UE 104B as in the first example, d_in=d_avg−d_out=25.6 km, t_in=3.28 s and energy savings are 80%.

In a third example, it may be assumed that a worst distance (a time the UE is in the coverage area, i.e., time of stay, ToS=1 s) applies for the UE 104C, which is d_min=7.8 km. Repeating the same calculations as in the first example for the UE 104C, d_in=d_min−d_out=1.56 km, t_in=0.2 s and energy savings are 20%.

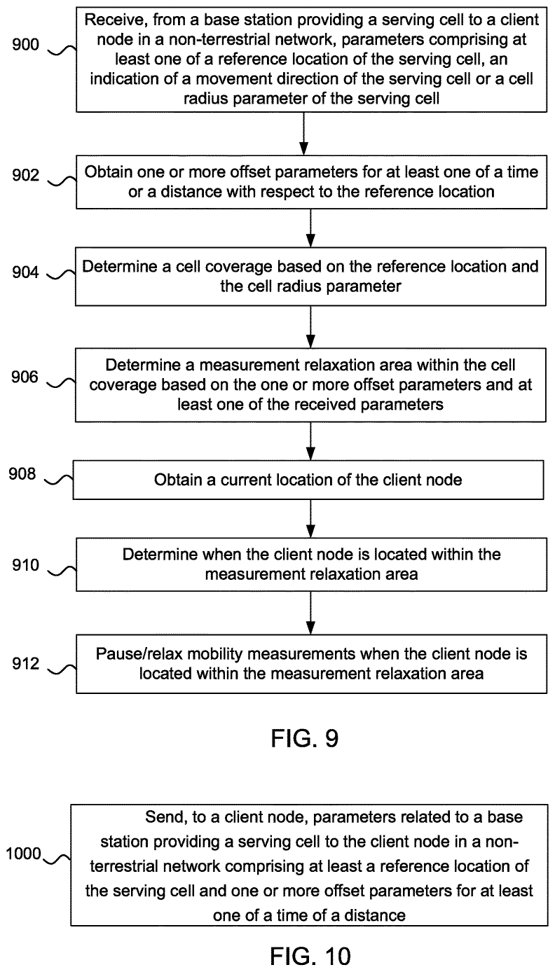

FIG. 9 illustrates an example of a method for controlling mobility measurements in an NTN network according to an example embodiment. The method may be performed, for example, by a client node such as a UE.

At an operation 900, the method may comprise receiving, from a base station providing a serving cell to a client node in a non-terrestrial network, parameters comprising at least one of a reference location of the serving cell, an indication of a movement direction of the serving cell and a cell radius parameter of the serving cell.

At an operation 902, the method may comprise obtaining one or more offset parameters for at least one of a time or a distance with respect to the reference location. The one or more offset parameters may be determined, for example, by the UE or received from the base station.

At an operation 904, the method may comprise determining a cell coverage based on the reference location and the cell radius parameter.

At an operation 906, the method may comprise determining a measurement relaxation area within the cell coverage based on the one or more offset parameters and at least one parameter received from the base station.

At an operation 908, the method may comprise obtaining a current location of the client node. For example, the apparatus or the client node may be configured to determine its own location, for example, based on GPS, a 3GPP-based positioning means or a hard-coded location.

At an operation 910, the method may comprise determining when the client node is located within the measurement relaxation area.

At an operation 912, the method may comprise pausing or relaxing mobility measurements when the client node is located within the measurement relaxation area. Hence, the apparatus may determine at least some of the mobility measurements not to be performed by the client node that would otherwise be performed when the client node is located within the serving cell. For example, the client node may be configured not to perform any mobility measurements, while in the measurement relaxation area, or configured to perform measurements at a reduced rate (e.g., fewer measurements in a time domain) or to measure less neighbor cells/frequency layers.

FIG. 10 illustrates an example of a method for assisting in controlling mobility measurements in an NTN network according to an example embodiment. The method may be performed, for example, by a base station such as a gNB.

At 1000, the method may comprise sending, to a client node, parameters related to a base station providing a serving cell to the client node in a non-terrestrial network comprising at least a reference location of the serving cell and one or more offset parameters for at least one of a time of a distance. The parameter may further comprise at least one of an indication of a movement direction of the serving cell or a cell radius parameter of the serving cell.

Further features of the methods directly result from the functionalities and parameters of the apparatuses, as described in the appended claims and throughout the specification and are therefore not repeated here. It is noted that one or more operations of the method may be performed in different order.

An apparatus, for example a network node, a user node or a client node, may be configured to perform or cause performance of any aspect of the method(s) described herein. Further, a computer program may comprise instructions for causing, when executed, an apparatus to perform any aspect of the method(s) described herein. Further, an apparatus may comprise means for performing any aspect of the method(s) described herein. According to an example embodiment, the means comprises at least one processor, and memory including program code, the at one memory and the program code configured to, when executed by the at least one processor, cause performance of any aspect of the method(s).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1. An apparatus, comprising:
at least one processor; and
at least one memory including instructions which, when executed by the at least one processor, cause the apparatus at least to:
receive, from a base station providing a serving cell to a client node in a non-terrestrial network, parameters comprising at least one of a reference location of the serving cell, an indication of a movement direction of the serving cell and a cell radius parameter of the serving cell;
obtain one or more offset parameters for at least one of a time or a distance with respect to the reference location;
determine a cell coverage based on the reference location and the cell radius parameter;
determine a measurement relaxation area within the cell coverage based on the one or more offset parameters and at least one of the parameters received from the base station;
obtain a current location of the client node;
determine when the client node is located within the measurement relaxation area; and
determine at least some of mobility measurements not to be performed by the client node when the client node is located within the measurement relaxation area.

2. The apparatus of claim 1, wherein the one or more offset parameters are received from the base station or determined by the apparatus.

3. The apparatus of claim 2, wherein the at least one memory includes instructions which, when executed by the at least one processor, cause the apparatus to:
determine a second reference location of the serving cell based on the one or more offset parameters and the indication of the movement direction;
determine a second cell coverage based on the second reference location and the cell radius parameter; and
determine the measurement relaxation area to comprise an at least partially overlapping area of the second cell coverage and a first cell coverage.

4. The apparatus of claim 2, wherein the at least one memory further comprises instructions which, when executed by the at least one processor, cause the apparatus to:
obtain a second cell radius parameter for the serving cell;
determine a second reference location of the serving cell based on the one or more offset parameters and the indication of the movement direction;
determine a second cell coverage based on the second reference location and the second cell radius parameter; and
determine the measurement relaxation area based on an overlapping area of the second cell coverage with a first cell coverage.

5. The apparatus of claim 4, wherein the indication of the movement direction comprises satellite ephemeris; and
wherein the at least one memory further comprises instructions which, when executed by the at least one processor, cause the apparatus to:
determine the second reference location based on the satellite ephemeris and the one or more offset parameters.

6. The apparatus of claim 1, wherein the one or more offset parameters comprise an array of time or distance parameters representing different distances from the first reference location; and the at least one memory comprises instructions which, when executed by the at least one processor, cause the apparatus to:
determine a trailing edge of the measurement relaxation area with respect to the movement direction extending across the first cell coverage perpendicular to the movement direction of the serving cell based on the array; and wherein
the measurement relaxation area comprises a part of the first cell coverage defined by the trailing edge.

7. The apparatus of claim 1, wherein the one or more offset parameters comprise an array of distances associated with a plurality of reference locations within the serving cell; and the at least one memory comprises instructions which, when executed by the at least one processor, cause the apparatus to:
determine a trailing edge of the measurement relaxation area with respect to the movement direction extending across the first cell coverage perpendicular to the movement direction of the serving cell based on the array; and wherein
the measurement relaxation area comprises a part of the first cell coverage defined by the trailing edge.

8. The apparatus of claim 1, wherein the at least one memory further comprises instructions which, when executed by the at least one processor, cause the apparatus to:
determine a measurement area based on the first cell coverage not included in the measurement relaxation area;
determine when the client node is located within the measurement area; and
perform the mobility measurements when the client node is located within the measurement area.

9. The apparatus of claim 1, wherein the at least one memory further comprises instruction which, when executed by the at least one processor, cause the apparatus to:
compare a distance between the client node and a trailing edge of the measurement relaxation area with respect to the movement direction of the serving cell to a predefined threshold; and
perform the mobility measurements when the distance between the client node and the trailing edge is less than the predefined threshold.

10. The apparatus of claim 1, wherein the indication of the movement direction of the serving cell comprises satellite ephemeris; and
wherein the at least one memory further comprises instruction which, when executed by the at least one processor, cause the apparatus to:
estimate a time until the client node is located at a trailing edge of the measurement relaxation area with respect to the movement direction based on a current location of the client node and the satellite ephemeris;
set a timer based on the estimated time; and
start the mobility measurements based on an expiration of the timer.

11. The apparatus of claim 1, wherein the indication of the movement direction of the serving cell comprises satellite ephemeris; and
wherein the at least one memory further comprises instruction which, when executed by the at least one processor, cause the apparatus to:
estimate a point of time when the client node is located at a trailing edge of the measurement relaxation area with respect to the movement direction based on a current location of the client node and the satellite ephemeris; and
perform the mobility measurements at the estimated point of time.

12. An apparatus, comprising:
at least one processor; and
at least one memory including instructions which, when executed by the at least one processor, cause the apparatus at least to:
send, to a client node, parameters related to a base station providing a serving cell to the client node in a non-terrestrial network comprising at least a reference location of the serving cell and one or more offset parameters for at least one of a time of a distance.

13. The apparatus of claim 12, wherein the one or more offset parameters comprise at least one of an array of time or distance parameters representing different distances from the first reference location, an array of time or distance parameters representing different distances from the first reference location and positioned between 0 to 180 degrees with respect to an axis perpendicular to the moving direction, an array of distances associated with a plurality of reference locations within the serving cell, or an array of distances associated with a plurality of reference locations within the serving cell on the axis perpendicular to the moving direction.

14. A method, comprising:
receiving, from a base station providing a serving cell to a client node in a non-terrestrial network, parameters comprising at least one of a reference location of the serving cell, an indication of a movement direction of the serving cell and a cell radius parameter of the serving cell;
obtaining one or more offset parameters for at least one of a time or a distance with respect to the reference location;
determining a cell coverage based on the reference location and the cell radius parameter;
determining a measurement relaxation area within the cell coverage based on the one or more offset parameters and at least one of the parameters received from the base station;
obtaining a current location of the client node;
determining when the client node is located within the measurement relaxation area; and
determining at least some of mobility measurements not to be performed by the client node when the client node is located within the measurement relaxation area.

15. The method of claim 14, wherein the one or more offset parameters are received from the base station or determined by the client node.

16. The method of claim 15, wherein the method comprises:
determining a second reference location of the serving cell based on the one or more offset parameters and the indication of the movement direction;
determining a second cell coverage based on the second reference location and the cell radius parameter; and
determining the measurement relaxation area to comprise an at least partially overlapping area of the second cell coverage and a first cell coverage.

17. The method of claim 15, wherein method comprises:
obtaining a second cell radius parameter for the serving cell;
determining a second reference location of the serving cell based on the one or more offset parameters and the indication of the movement direction;
determining a second cell coverage based on the second reference location and the second cell radius parameter; and
determining the measurement relaxation area based on an overlapping area of the second cell coverage with a first cell coverage.

18. The method of claim 17, wherein the indication of the movement direction comprises satellite ephemeris, and wherein the method further comprises determining the second reference location based on the satellite ephemeris and the one or more offset parameters.

19. The method of claim 15, wherein the one or more offset parameters comprise an array of time or distance parameters representing different distances from the first reference location, and wherein the method further comprises:
determining a trailing edge of the measurement relaxation area with respect to the movement direction extending across the first cell coverage perpendicular to the movement direction of the serving cell based on the array; and
wherein the measurement relaxation area comprises a part of the first cell coverage defined by the trailing edge.

20. The method of claim 15, wherein the one or more offset parameters comprise an array of distances associated with a plurality of reference locations within the serving cell, and wherein the method further comprises:
determining a trailing edge of the measurement relaxation area with respect to the movement direction extending across the first cell coverage perpendicular to the movement direction of the serving cell based on the array; and
wherein the measurement relaxation area comprises a part of the first cell coverage defined by the trailing edge.

21-28. (canceled)
